(19) United States
(12) Patent Application Publication
(10) Pub. No.: US 2015/0039342 A1
(43) Pub. Date: Feb. 5, 2015

(54) TRACKING OF PHYSIOLOGICAL OR MEDICINAL SAMPLES

(71) Applicant: TrakCel Ltd., Mid Glamorgan Bridgend (GB)

(72) Inventors: Bin Chen, Mid Glamorgan (GB); Akshay Peer, Mid Glamorgan (GB)

(73) Assignee: TrakCel Ltd., Mid Glamorgan Bridgend (GB)

(21) Appl. No.: 14/373,907

(22) PCT Filed: Feb. 7, 2013
(86) PCT No.: PCT/GB2013/050282

§ 371 Date: Jul. 23, 2014

(30) Foreign Application Priority Data
Feb. 10, 2012 (GB) 1202368.5

(51) Int. Cl. G06F 19/00

(52) U.S. Cl. CPC G06F 19/366
USPC 705/3

(57) ABSTRACT

A tracking device captures biometric and other data for a sample matched to a patient from whom biometric data has been stored. The sample can proceed to subsequent steps only if there is identity between the captured biometric data and the stored biometric data. Where there is identity, a first processing operation is performed. A tracking device captures biometric data, other data concerning the sample and the first processing operation; the captured biometric data is compared with biometric data in the data repository. The sample can proceed only if there is identity between the captured biometric data and the stored biometric data; where there is identity, a further processing operation is performed. A tracking device captures biometric data, other data concerning the sample and the further processing operation; the captured biometric data is compared with biometric data in the data repository. These steps are repeated as many times as needed.

The present invention relates to a method of tracking of one or more samples through a plurality of processing, treatment, handling and development stages, such as in the preparation and processing of tissue, physiological material or medicinal material suitable for use in autologous or allogeneic treatment.

When preparing, handling, treating or processing of tissue, physiological material or medicinal material and the like, it is often necessary to subject the material to stringently controlled conditions, such as within narrow bands of or ranges of temperature and pH. In most cases, it is also necessary to perform various processing stages in a precisely ordered and timely sequence to ensure that the material remains in optimum or viable condition when subsequently administered to a patient. This is particularly important during the processing of autologous or allogeneic tissue-derived material from a biological sample of the patient to be treated.

Examples of physiological materials suitable for autologous or allogeneic treatment include bone marrow or blood transfusion samples, or stem cell or chondrocyte implantation tissue material. During handling and processing of such materials, they are subjected to various processing steps (typically analytical or preparative), which must be performed at specific or predefined times and/or in a predefined sequence. Although many of the analytical or preparative steps can be performed automatically, there is nevertheless a need for multiple manual steps, for example, in transfer of a sample vial from a despatch package to a test location. Such manual operations are conducive to human error which can result inadvertent omission of a particular step and/or the sample specific parameters, such as temperature and pH, wandering outside pre-determined ranges, especially as different stages may be carried out by different operators, located at different sites. Accordingly, the end product may be in unsuitable form, may be subject to deterioration, or be in less than optimum condition; or it may not be accurately identifiable to the patient from whom the sample has been taken and to whom the sample will be given.

Methods of tracking physiological samples are known from several prior art documents, such as WO03/042788; WO2008/112431 and WO2010/056287.

WO03/042788 describes a series of steps which comprises assigning a unique identifier to a sample, and using a reader to recognise the unique identifier and to obtain and record time and location data showing when and where the unique identifier has been recognised from the sample. This is a passive system and merely collects information about time and location initially.

WO2008/112431 and WO2010/056287 both describe systems to track patient specimens through collection and analysis steps using RFID technology. The systems described both associate identifiers of RFID tags with a patient record in an information management system or database. There is, however, no recognition of any reason to verify that the patient's identity and the relevant sample match at all key stages. If an error occurs at any step along the way, such as in a treatment step, it would only be apparent at a late (or final) stage—which might be after damage has been caused if that late or final stage is treatment of a patient.

In the field of personalised medicines, in which it is wished to track physiological materials suitable for autologous or allogeneic treatment of patients, we propose to provide a fully traceable audit trail for each sequential step, so that any errors become apparent when they arise (especially before a crucial step, such as treatment of a patient). Specifically, we propose a system which collects data concerning time, location, biometric details and the like, at key steps throughout the whole sequence of operations and which permits matching of the patient with the sample purported to be for that patient.

We have therefore now devised an improved method of tracking physiological samples suitable for autologous or allogeneic treatment of patients, which method provides such an audit trail and also provides the ability to verifiably match a sample after multiple treatment steps with the patient for whom the sample is intended. The method according to the invention has the advantage of being proactive in helping to avoid errors being made, rather than the prior art tracking systems, which are generally merely reactive because they only serve to detect errors after they have been made.

The present invention provides a method of tracking at least one physiological or medicinal sample through a sequence of processing operations, using one or more tracking devices for tracking the sample, the method comprising the steps of:

(a) providing the sample from a source matched to a specific patient, and storing biometric data relating to the patient and data relating to the sample in a data repository;

(b) capturing in one said tracking device data relating to the sample, including said biometric data;

(c) permitting the sample from step (b) to proceed to subsequent steps only if there is identity between the biometric data captured in step (b) and the biometric data stored in step (a);

(d) in the case where there is such identity, carrying out a first processing operation on the sample;

(e) capturing in one said tracking device, which may be the same as or different to the tracking device used in said step (b), data relating to the sample, including the data captured in step (b) as well as data relating to the first processing operation;

(f) capturing in one said tracking device, which may be the same as or different to the tracking device used in said steps (b) and (e), data relating to the sample, including the data captured in steps (b) and (e);

(g) comparing the biometric data captured in step (f) with biometric data relating to the patient stored in the data repository;

(h) permitting the sample to proceed to a further processing operation (i) only if there is identity between the stored biometric data and the biometric data captured in step (f);

(i) in the case where there is such identity, carrying out a further processing operation on the sample;

(j) capturing in one said tracking device, which may be the same as or different to the tracking device(s) used in said steps (b), (e) and (f), data relating to the sample, including the data captured in steps (b) and (e) as well as data relating to the further processing operation (i), steps (f) to (j) comprising a cycle which is repeated one or more times; and

(k) comparing the captured data obtained in a final step (j) with data relating to the sample stored in the data repository and rejecting the sample if there is not identity between the stored biometric data and the biometric data captured in said final step (j).

Advantageously, the method according to the invention facilitates an ordered sequence of processing operations, so as to ensure that at each of steps (d) and (i) the sample is subjected to the correct predetermined conditions, in order to ensure that each step can be audited, and also to ensure that the sample is only permitted to progress to a further processing step when the correct preceding sequence of steps has taken place, with the correct operators, and in the correct order. After each processing operation, there is a synchronisation step which provides for an intermediate check on the status of the sample and the overall process before an operator is permitted to continue with any subsequent processing operations.

The tracking devices used in the method according to the invention preferably capture data relating to a patient and/or to at least one operator, including biometric information relating to the patient, to the operator, or to both. The tracking devices used at different points in the sequence of steps in the method according to the invention may be the same or different; advantageously different operators may use their own tracking devices provided that each such tracking device is configured for use in the method according to the invention. The captured biometric information, of either the patient or the operator, for example, may include fingerprint data, iris or vein pattern data, photographic data or the like.

Preferably, the method according to the invention further requires an operator of a respective tracking device to log in to the respective tracking device immediately before or at the start of each of steps (b) and (f), and to log out immediately after or at the end of the each of steps (e) and (j).

The relevant operator may be required to log in to the appropriate tracking device by using a smart card, a password, or biometric data relating to the operator. These features provide for the establishment of an auditable record of the relevant operators, for example, doctors, nurses, laboratory technicians, responsible for each step to provide a full traceability of the operator responsible for each step.

The data captured in steps (b), (e), (f) and (j) may comprise operator identification details or information, and time and location data of the item corresponding to a particular processing step. The location data may comprise site specific location data such as data identifying a particular area or building, floor of a building and/or room of a building. Such site specific location data may be provided by a machine readable label, such as a radio frequency identification tag (RFID), a barcode, or the like. As is known, a barcode is an optical machine-readable representation of data, which shows data about the object to which it attaches. Such a barcode may be of the known 1-D (one dimensional) type in the form of a series of optical machine readable light and dark bars or stripes, or of the known 2-D type (also known as a “quick response code” or QR code) where a matrix of optical machine readable light and dark areas is provided.

Alternatively, or in addition thereto, the location data may comprise site details or geographic location details, such as information concerning country and city. Such geographic details may be acquired by GPS or the like.

The data acquired and captured in steps (b), (e), (f) and (j) may alternatively, or additionally, comprise sample specific data, such as sample identification data, or data relating to conditions such as temperature and/or pH, which correspond to conditions to which the sample has been subjected during the respective processing step.

The data acquired in steps (b), (e), (f) and (j) may further comprise information specific to the sample or to its source, such as biometric data or personal data of the patient from whom the sample has been taken.

The sample used in the method according to the invention preferably comprises a biological sample, such as one used for autologous or allogeneic treatment. A specific example thereof is stem cell material. The initial steps—before step (a)—preferably comprise registering a patient and collecting the sample from the patient; and then nurturing the sample (such as the stem cell material) through various growth stages. Also it is preferred to take biometric data, such as the data described above, from the patient at the same time as or prior to step (a), for registration using the data repository. The registration step preferably includes recordal of other date relating to the patient, such as name, address, date of birth, date of registration, detail of the patient's condition, details of any appointments, and the like.

Preferably, a final step comprises returning at least part of the nurtured sample, such as stem cells, to the patient, after verifying that biometric data collected initially corresponds to that of the intended patient. Such a part of the sample may be a medicinal material.

The method according to the invention thus provides a suitable means of tracking samples, such as biological samples, suitable for use in autologous or allogeneic treatment or therapy.

The method according to the invention preferably further comprises identifying and recording the samples, at each of steps (d) and (i), in order to ensure that the sample is subjected to the appropriate steps. Such identifying and recording preferably comprises generating a human and/or machine-readable label with appropriate information concerning the sample, for a label to be applied to a portable container (such as a vial or bag) in which the sample is transported or processed. Such a machine-readable label may be a bar code or, preferably, an RFID tag.

Preferably, the method according to the invention further comprises generating a receipt, which comprises at least a portion of the sample data, at each of steps (d) and (i). Such a receipt is preferably arranged to provide an operator of the tracking device with a confirmation of the completion of the respective step. Such a receipt may further be applied to the abovementioned container, for example, as a label.

The method according to the invention is generally carried out using a tracking system for tracking a sample through a sequence of processing operations or cycles, the system comprising at least one tracking device for tracking sample processing operations and a data repository for storing data corresponding to the processing of the sample at each processing operation, the at least one tracking device being arranged to capture and record sample data at each of the processing operations and to synchronise with the data repository, to enable the transfer of sample data corresponding to the respective processing operation, between the repository and the at least one tracking device.

The system preferably further comprises communication means which can enable the at least one tracking device and the data repository to communicate data one to the other (that is, at least from the tracking device to the data repository, and preferably, in some embodiments, from the data repository to at least some of the tracking devices).

Preferred embodiments of the method and system according to the present invention will now be described by way of example only and with reference to the accompanying drawings, in which:

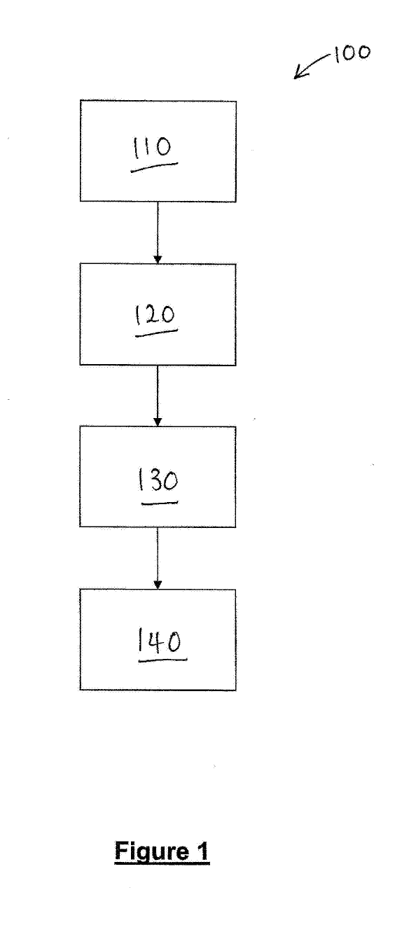

FIG. 1 is a flowchart outlining the principal processing steps associated with a sequence of processing steps for a sample, according to an embodiment of the present invention;

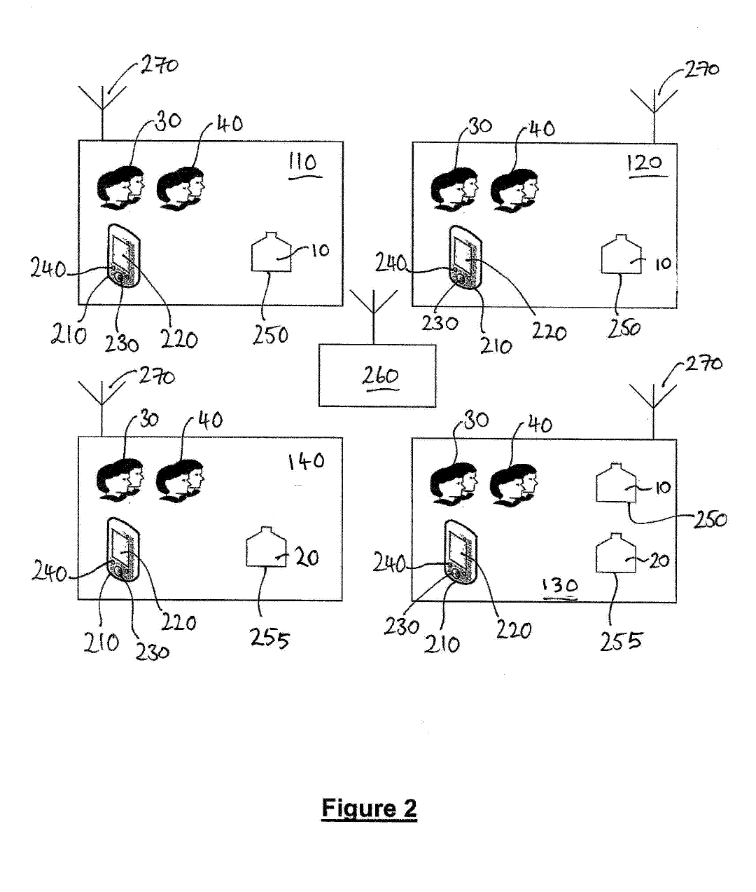

FIG. 2 is a more detailed schematic representation of the embodiment of FIG. 1;

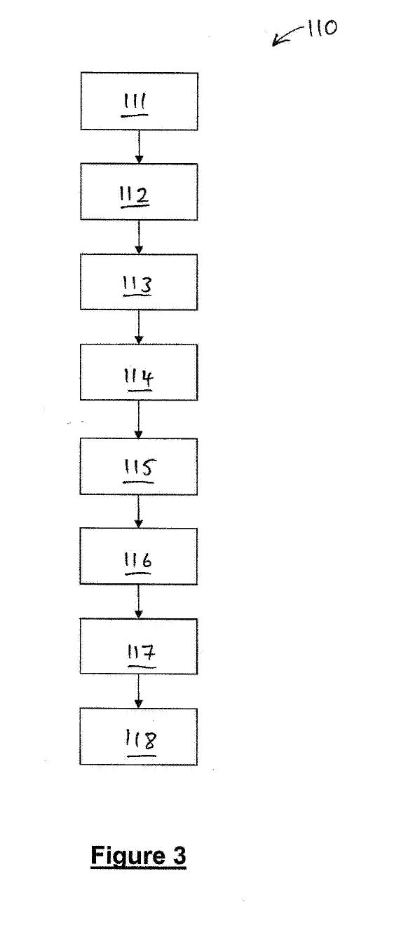

FIG. 3 is a flowchart outlining exemplary subsidiary stages associated with the sample collection step illustrated in FIGS. 1 and 2;

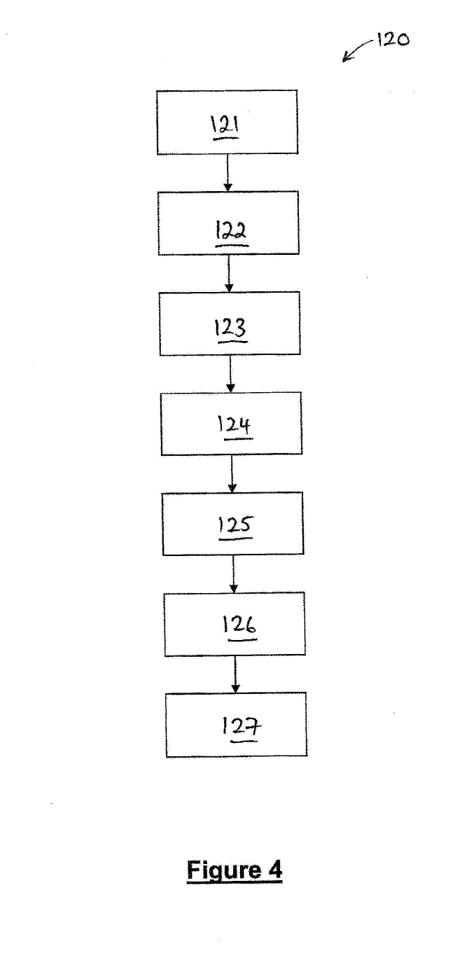

FIG. 4 is a flowchart outlining exemplary subsidiary stages associated with the logistics step illustrated in FIGS. 1 and 2;

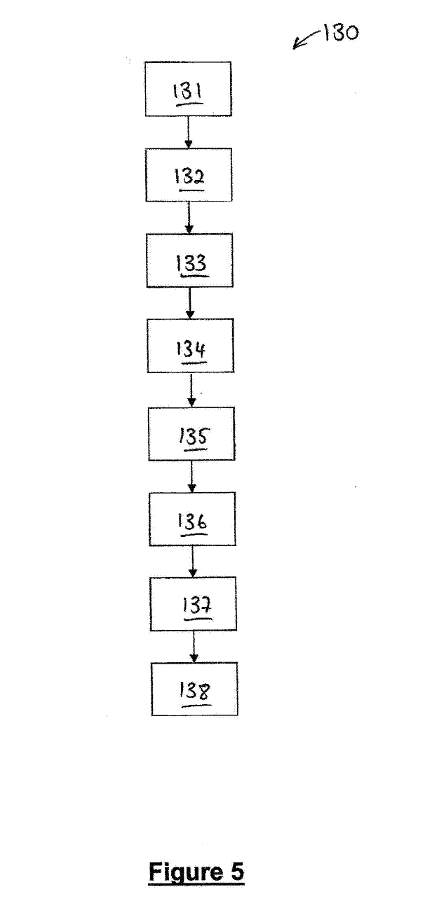

FIG. 5 is a flowchart outlining the exemplary subsidiary stages associated with the sample processing step illustrated in FIGS. 1 and 2; and

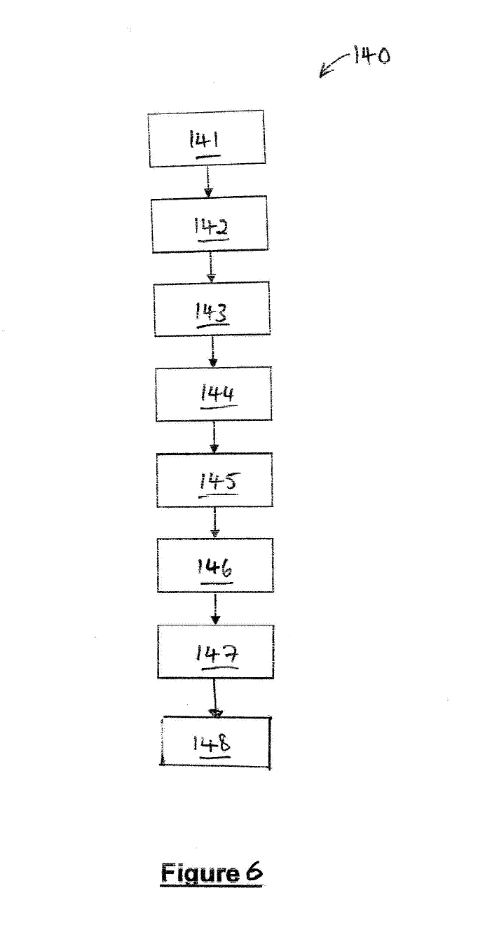

FIG. 6 is a flowchart outlining exemplary subsidiary stages associated with the treatment step illustrated in FIGS. 1 and 2.

FIGS. 1 and 2 of the drawings illustrate principal steps associated with a method 100 of tracking a sample 10 (FIG. 2), according to an embodiment of the present invention in a sequence of steps. The sample 10 is typically in a vial or other container 250 and comprises a physiological material harvested or collected from a patient 30 by medical personnel 40 in sample collection step 110.

The sample 10 is then passed to logistics step 120, where the sample is subjected to one or more logistical operations, generally in a precise sequence of operations. According to the invention it is necessary to monitor the sample 10 during the logistical operations to ensure controlled conditions.

After the logistical operation(s), the sample is processed in one or more processing steps 130 to produce a medicinal or other physiologically active material 20. Once the latter material 20 has been produced, it is then administered to the patient 30 in administration step 140. It is to be appreciated, however, that while the method 100 is primarily intended for the preparation and/or processing of an autologous or allogeneic medicinal material, other medicinal or physiological samples which require a specific sequence of operations may also be employed in the method of the present invention.

The illustrated method 100 comprises four principal sequential steps 110, 120, 130, 140, the first of which comprises a harvesting or sample collection step for collecting a physiological sample 10 from the patient 30. The harvested sample 10 is then suitably labelled at logistics step 120 to enable the identification of the sample 10 before undergoing one or more processing steps 130 whereby the sample is processed to create a medicinal or physiologically active material 20. After processing as described, the final principal step in the illustrated embodiment comprises an administration step 140 for administering the medicinal or physiological material 20 to the patient 30.

Referring to FIG. 2 of the drawings, there are also shown features of a tracking system for tracking the sample 10 through the various principal steps 110, 120, 130, 140 of the method according to the invention. The tracking system comprises a plurality of tracking devices 210 which may each comprise, for example, a handheld and/or table mounted or desktop device, each of which is constrained so as to be operated solely by registered operators 40, such as doctors, nurses, technicians and the like.

The tracking devices 210 are arranged to capture or acquire data relating to the sample 10 at each principal step 110, 120, 130, 140 in addition to providing the respective operator 40 with information regarding the prior operational step and the requirements for the current operational step, via a display screen 220 on the respective device. The acquisition of data may comprise the manual recordal of data using a data entry device 230, such as a keypad (not shown) on the device 210.

Alternatively, the acquisition of data may comprise an automated recordal via a reader 240, such as a barcode or radio-frequency identification (RFID) tag reader, which is arranged to read labels (not shown) provided on receptacles 250 which have been prepared to receive samples 10, and/or on receptacles 255 which have been prepared to receive physiological or medicinal material 20 which is obtained from samples 10 and is to be administered to a patient 30 (in administration step 140).

The tracking devices 210 are further arranged to synchronise with a central data storage or repository 260 at each principal step 110, 120, 130, 140 to enable the transfer of data between the respective device 210 and the repository 260. In this respect, the tracking devices 210 and central repository 260 comprise separate communication units 270 for enabling wireless communication between the respective tracking device and the central repository.

Referring to FIG. 3 of the drawings, preferred details of the first principal step 110 (harvesting of the physiological sample from a patient 30 as described above) will now be described.

Before an operator is permitted to obtain the sample, the operator 40 (such as a registered doctor or nurse) is first required to log in to the system at log in operation 111 using a tracking device such as 210 as described with reference to FIG. 2. As indicated, such a tracking device could be a handheld device such as a smartphone, or a personal computer or the like. The operator may be required to log in by entering his/her unique access code using a data entry device 230 such as that described above with reference to FIG. 2. This provides for a register of operators responsible for the processing of the sample, and particularly, the operator(s) responsible for a particular operation.

The tracking device 210 is subsequently arranged to synchronise with the repository 260 at synchronisation operation 112 to initialise the tracking device 210 with the appropriate data relating to the initial harvesting step 110. The respective patient's details are then obtained and entered onto the tracking device 210, together with biometric details of the patient 30, such as photographic image and/or fingerprints at entry operation 113. The sample 10 is subsequently obtained and placed within a pre-prepared receptacle at packing operation 114.

The time and location of the event is then recorded at recordal operation 115 on the tracking device 210 and a receipt (not shown) is generated at receipt operation 116 to provide a confirmation of the initial principal step. Finally, the tracking device 210 is arranged to further synchronise with the repository 260 at further synchronisation operation 117 to update the repository with data relating to the sample 10, namely the patient's details, biometric information and the time and location of the event. The operator subsequently logs out from the system at log out operation 118.

Referring to FIG. 4 of the drawings, preferred details of the logistics step 120 are shown, whereby the sample is identified and labelled. During this step, the operator 40 responsible is required to first log in to the system at log in operation 121 using a tracking device 210 (see FIG. 2), which may be a different device to that used during the first harvesting step 110, since the logistics step 120 may be carried out in a different room or building, or even in a different city, to the first step.

Once the operator 40 has logged into the system, the tracking device 210 is arranged to synchronise with the repository at synchronisation operation 122 to update the tracking device 210 with the sample details acquired during the first step 110 so that the operator 40 of the logistics step 120 becomes informed about the sample 10. The tracking device 210 subsequently records the time and location of the logistics step 120 at recordal operation 123 and the operator 40 identifies the sample at identification operation 124. In this case, the operator identifies the sample and generates a machine readable label (not shown), such as a radio-frequency identification tag or label or a barcode label for example, and applies the label to the receptacle 250 (see FIG. 2), so that the sample can be identified from the label (not shown) using a label reader 240 provided on the tracking devices 210.

The operator subsequently generates a receipt at receipt operation 125 as confirmation of the subsidiary operations performed during the logistics step 120 and arranges for the tracking device 210 to synchronise with the repository at synchronisation operation 126, so that the repository 260 becomes up-dated with the information regarding the logistics step 120. Once synchronised, the operator subsequently logs out from the system at log out operation 127.

Referring to FIG. 5 of the drawings, preferred details of the sample processing operation 130 are shown, whereby the physiological sample, such as a collection of stem cells, is grown through several growth operations. In this case, the operator may manually separate the sample 10 into several pre-prepared further receptacles 250.

The operator of the processing operation 130 is required to log in to the system at log in operation 131 typically using a biometric reader, in order to verify the operator and check their relevant qualifications and permissions. There is then a synchronisation operation 132 so that the system becomes up-dated with the sample information, sample processing information, required receptacles 250,255 and the like, and the operator 40 places the receptacle comprising the original sample to a receiving station at recordal operation 133.

The sample 10 in receptacle 250 is then identified in identification operation 134 (typically using a sensor to verify various parameters of the sample 10, such as the temperature, volume, weight and the like). The operator 40 subsequently processes the sample at update operation 135, typically according to instructions provided on a display screen (not shown), and once the processing has been completed, a receipt or traceability record of the sample 10 is generated at receipting operation 136, including details of which samples are in which receptacle 250 and of the latest state of each sample. The data are subsequently synchronised with the repository 260 in a synchronization operation 137 to up-date the data repository 260 (FIG. 2) with information regarding the sample processing operation. The operator subsequently logs out from the system at synchronisation operation 138.

Preferred features of the treatment operation will now be described with reference to FIG. 6 of the accompanying drawings. In this preferred arrangement, the treatment operation 140 first requires the operator 40 responsible for treatment to first log in to the system at log in log-in step 141 using a tracking device 210, which may be a different device to that used during the previous steps 110, 120, 130. Once the operator 40 has logged into the system, the tracking device 210 is arranged to synchronise with the data repository 260 at synchronisation operation 142 in order to update the tracking device 210 with the details acquired during the previous steps 110, 120, 130 so that the operator 40 becomes informed about the medicinal material 20 in receptacle 255. The tracking device 210 subsequently records the time and location of at recordal operation 143 and the operator 40 confirms the identity of the medicinal material 20 at identification operation 144 by reading the label on the respective receptacle 255 using the device reader 240.

The patient is subsequently verified, generally using the biometric information acquired during the first step 110 at verification operation 145, to ensure that the physiological or medicinal material 20 in receptacle 255 is matched and therefore appropriate for the patient. Once the patient and the medicinal material have been matched and verified in this way, the medicinal material 20 is administered by the operator 40 at administration operation 146 and the tracking device 210 updated with the details of the administration, such as the time and location at update operation 147. A final receipt is then generated at log out step 148 as confirmation of all the operations associated with the final treatment operation 140.

The method 100 and system thus facilitate an improved preparation and/or processing of an item such as a medicinal or physiological material 20, through a periodic synchronising of the tracking devices 210 with a central repository 260, and thus reduce errors associated with manual preparation of the physiological or medicinal material 20.

While the numeral 40 has been used for operators in each of the steps illustrated in FIG. 2, it will be understood that different operators may be employed at different steps; equally, different tracking devices 210 and communication units 270 may be employed at different steps.

1. A method of tracking at least one sample through a sequence of processing operations using at least one tracking device for tracking the sample, the method comprising the steps of:
(a) providing a sample from a source matched to a patient, and storing biometric data relating to the patient and data relating to the sample in a data repository;
(b) capturing in a first tracking device data relating to the sample, including the biometric data;
(c) permitting the sample from step (b) to proceed to subsequent steps only if there is identity between the biometric data captured in step (b) and the biometric data stored in step (a);
(d) in the case where there is such identity, carrying out a first processing operation on the sample;
(e) capturing in a second tracking device data relating to the sample, including the data captured in step (b) as well as data relating to the first processing operation;
(f) capturing in a third tracking device, data relating to the sample, including the data captured in steps (b) and (e);
(g) comparing the biometric data captured in step (f) with biometric data relating to the patient stored in the data repository;
(h) permitting the sample to proceed to a further processing operation (i) only if there is identity between the stored biometric data and the biometric data captured in step (f);
(i) in the case where there is such identity, carrying out a further processing operation on the sample;
(j) capturing in a fourth tracking device data relating to the sample, including the data captured in steps (b) and (e) as well as data relating to the further processing operation (i), steps (f) to (j) comprising a cycle which is repeated one or more times; and
(k) comparing the captured data obtained in step (j) with data relating to the sample stored in the data repository and rejecting the sample if there is not identity between the stored biometric data and the biometric data captured in step (j).

2. The method according to claim 1, wherein an operator of the respective tracking device of steps (b) and (f) is required to log in immediately before or at the start of each steps (b) and (f).

3. The method according to claim 1, wherein the data relating to the sample acquired in steps (e), (f) and (j) comprise:
operator details;
time and location information concerning the sample corresponding to a particular processing step for the sample; and
optionally information identifying the sample.

4. The method according to claim 3, wherein the location information is site specific location data.

5. The method according to claim 1 further comprising registering the patient, including biometric details relating to the patient to the data repository before to step (a).

6. The method according to claim 5 further comprising collecting the sample from the registered patient before step (a).

7. The method according to claim 5 further comprising readying the sample for administration to the registered patient after step (k).

8. The method according to claim 7 identifying and verifying the registered patient by biometric data before the administration.

9. The method according to claim 1 further comprising identifying and recording the sample at step (d).

10. The method according to claim 1 further comprising generating a receipt at step (d).

11. The method according to claim 1, wherein the first, second, third and fourth tracking devices comprise the same tracking device.

12. The method according to claim 1, wherein the first, second, third and fourth tracking devices each comprise different tracking devices from one another.

13. The method according to claim 1, wherein one or more of the first, second, third and fourth tracking devices comprise the same tracking device.

14. The method according to claim 1, wherein the first, second, third and fourth tracking devices each are selected from the group consisting of a portable device, a handheld device, a smartphone, and a computer.

15. The method according to claim 1, wherein an operator of the respective tracking device of steps (e) and (j) is required to log out immediately after or at the end of each of steps (e) and (j).

16. The method according to claim 1 further comprising identifying and recording the sample at each step (i).

17. The method according to claim 1 further comprising generating a receipt at each step (i).

18. The method according to claim 10, wherein the receipt comprises at least a portion of the data relating to the sample.

19. The method according to claim 17, wherein the receipt comprises at least a portion of the data relating to the sample.

20. A method of tracking at least one sample through a sequence of processing operations using at least one tracking device for tracking the sample, the method comprising the steps of:
(a) registering a patient, including biometric details relating to the patient, to a data repository;
(b) collecting a sample is collected from the registered patient;
(c) providing the sample from a source matched to the patient, and storing biometric data relating to the patient and data relating to the sample in the data repository;
(d) capturing in a tracking device data relating to the sample, including the biometric data;
(e) permitting the sample from step (d) to proceed to subsequent steps only if there is identity between the biometric data captured in step (d) and the biometric data stored in step (c);
(f) in the case where there is such identity, carrying out a first processing operation on the sample, identifying and recording the sample, and generating a receipt;
(g) capturing in a tracking device that can be the same as or different from the tracking device used in step (d), data relating to the sample, including the data captured in step (d) as well as data relating to the first processing operation;
(h) capturing in a tracking device that can be the same as or different from the tracking device(s) used in steps (d) and (g), data relating to the sample, including the data captured in steps (d) and (g);
(i) comparing the biometric data captured in step (h) with biometric data relating to the patient stored in the data repository;
(j) permitting the sample to proceed to a further processing operation (k) only if there is identity between the stored biometric data and the biometric data captured in step (h);
(k) in the case where there is such identity, carrying out a further processing operation on the sample, identifying and recording the sample, and generating a receipt;
(l) capturing in a tracking device that can be the same as or different from the tracking device(s) used in steps (d), (g) and (h), data relating to the sample, including the data captured in steps (d) and (g) as well as data relating to the further processing operation (k), steps (h) to (l) comprising a cycle which is repeated one or more times;
(m) comparing the captured data obtained in step (l) with data relating to the sample stored in the data repository and rejecting the sample if there is not identity between the stored biometric data and the biometric data captured in step (l);
readying the sample for administration to the registered patient; and
administering the sample to the registered patient;
wherein an operator of the respective tracking device of steps (d) and (h) is required to log in immediately before or at the start of each of steps (d) and (h);
wherein an operator of the respective tracking device of steps (g) and (l) is required to log out immediately after or at the end of each of steps (g) and (l);
wherein the data relating to the sample acquired in steps (g), (h) and (l) comprise:
operator details;
time and location information concerning the sample corresponding to a particular processing step for the sample; and
optionally information identifying the sample; and
wherein the receipt comprises at least a portion of the data relating to the sample.
